(19) United States
(12) Patent Application Publication
(10) Pub. No.: US 2005/0236478 A1
(43) Pub. Date: Oct. 27, 2005

(54) Port and cargo security

(76) Inventors: John A. St. Clair, Alhambra, CA (US); Gregory Keever, Los Angeles, CA (US)

Correspondence Address: COUDERT BROTHERS LLP, 333 SOUTH HOPE STREET, 23RD FLOOR, LOS ANGELES, CA, 90071, US

(21) Appl. No.: 11/112,144

(22) Filed: Apr. 22, 2005

Related U.S. Application Data
(60) Provisional application No. 60/566,135, filed on Apr. 27, 2004.

(51) Int. Cl. G07B 15/02

(52) U.S. Cl. 235/384

(57) ABSTRACT

A system, a method, and an apparatus for decreasing the delay in the inspection of a containers at a port. The containers are tagged with a device at the originating port embedded with certain criteria that can be put under surveillance until the containers reach the destination port. A communication device such as a satellite is used to track the containers every step of the way until they reach the destination port, and to continuously or periodically transmit to the destination port the results of surveilling the containers. If the information embedded remains consistent with a profile, then the containers spend little or no time at every point of inspection between the point of origin and the destination port. If, on the other hand, the surveilling information shows any change in the tag from the profile, then the container is first isolated and a complete inspection is made.

### RELATED APPLICATION

The applicant claims priority to Provisional Patent Application No. 60/566,135 filed Apr. 27, 2004, entitled “PORT AND CARGO SECURITY” and naming inventors John A. St. Clair and Gregory Keever.

### BACKGROUND OF THE INVENTION

1. Field of the Invention

The present invention relates to the field of security, and in particular to a system, a method, and an apparatus for tagging a container and possibly its contents at its point of origin, surveilling the container and its contents until it reaches its destination port, and inspecting the container and its contents at its destination port if needed.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

With the globalization of commerce and a free trade market system, most countries import goods from other countries and export goods to other countries on a daily basis. After recent terrorist attacks and the constant danger of future unexpected attacks, the level of security at ports around the world has increased. Typically the increased security has required additional inspections and searching of containers and goods. This security increases the time goods have to spend at the ports, with a result that commerce is greatly negatively affected. The more time that a container spends in a port means lower throughput for the port. This results in increased costs of port operations and increases the cost of imported goods. Companies get their products after a delay in the importation resulting from the inspection/verification procedures which often cause the goods to be spoiled or to arrive too late for their intended purpose. In almost all instances, the inspection/verification procedures increase the cost of the imported goods due to the delay, most, and often all of such cost is passed on to the consumer.

Other drawbacks in the current inspection/verification procedures include that goods within a container may contain unwanted materials, terrorists, or otherwise are not identified at all, or only follow a superficial physical inspection at the receiving port. Discovery of such materials, whether or not such materials subsequently turn out to be harmless or totally legitimate, may require the entire port to be shut down and/or quarantined, further reducing throughput and adding to the delay in time and expense of importing goods.

### SUMMARY OF THE INVENTION

The present invention is a system, a method, and an apparatus for avoiding, circumventing, obviating, in some instances, and decreasing the delay of, in other instances, in the inspection of goods at a port by making a container and its contents “trustable.” Goods that are imported into ports via ships are shipped and stored in large containers. The goods within a container, the container, or both are “tagged” with a device (tag) at the point of origin (manufacturer or exporter) or a port of shipment. This tag has embedded certain criteria and data that can be put under constant surveillance until it reaches the destination port. To qualify as “trustable”, the tagging is either performed by a licensed and authorized company, such as for example a qualified shipper, or by the security personnel of the country of origin. The “tagging” is by means, such as for example, of a radio frequency identification device (RFID) tag or chip capable of storing the criteria and data, of directly communicating via a device such as a satellite, or of being either “read” by a device capable of such communication (passive tag) or of being powered continuously by a power source such as a battery (active tag), and is used to track the goods every step of the way from the point of origin or port of shipment to the destination port. The communication device also performs the dual function of transmitting to the destination port the results of surveilling the goods. If the relevant information embedded in the tag remains as expected, then the goods spend little or no time at every point of inspection between the port of shipment or point of origin and the destination port. If, on the other hand, the surveilling information shows any change in the tag from the expected values, then the goods are, first, isolated and, then, a complete inspection is made.

### BRIEF DESCRIPTION OF THE DRAWINGS

These and other features, aspects and advantages of the present invention will become better understood with regard to the following description, appended claims, and accompanying drawings where:

FIG. 1 illustrates an overview of the present invention.

FIG. 2 illustrates a flowchart of the functions of the module.

### DETAILED DESCRIPTION OF THE INVENTION

The embodiments of the present invention are a system, a method, and an apparatus for providing a trustable shipping container. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

In the financial industry, banks communicate finds and transactions to each other via clearinghouses and private networks. Over time, certain schemes of documentation and identification have been developed so that some financial instruments are what are known as “trusted” instruments. For example, non-counterfeit U.S. Currency, bank drafts, bearer bonds, money orders, etc., are trusted in the sense that they are assumed valid. This permits financial transactions to flow freely and efficiently because little or no time is spent verifying such trusted instruments. On the other hand, non-trusted instruments, such as personal checks and credit cards, require some sort of authorization and verification before acceptance. Thus, trusted instruments are preferred over others.

The same approach is developed in the shipping industry. By making some containers and their contents “trustable”, it is possible to expedite their processing at both the point of origin and destination port and all ports in-between where halts are made by the ship by avoiding time consuming inspection and verification processes that slow down port throughput.

Certified Shipper

According to one embodiment of the invention, a shipper is certified as an authorized shipper under the system. This means that the shipper has been inspected and is determined to have a secure facility and the ability to determine and certify that what contents they believe is sealed into shipping containers, and only those contents, are in fact in the container. A certified shipper must also have the ability to seal the container and to detect, or cause to be detected, tampering of the seal after release into the shipping network. According to one embodiment, the container is tagged with an identification device. According to another embodiment, each content of a container is tagged with an identification device. For example, each bottle of Aspirin is tagged with the device. According to another embodiment, the container and its contents are both tagged with an identification device. For example, a certain number of the Aspirin bottles are in turn packed within a box, which could have its own tag. This box along with other boxes could be further packed within a larger container which could have its own tag. This means that there is no limit to the number of tagging levels. It also means that even if a single Aspirin bottle is subject to a change (such as for example, difference in weight or other readily measured physical or chemical parameter), then this change is transmitted to a tagging device (explained further below) tracking the container, thereby triggering inspection of all Aspirin bottles within the container.

Tagging Device

The tagging device may be an RFID tag. These tags are either passive tags that have to be “awakened” by a local receiver or active tags that are constantly powered by a power source such as a battery. In either case, the entire data or specific portions of the data from the tag can be retransmitted, such as via a satellite or other communications link to one or more central database locations accessible by authorized governmental authorities, law enforcement agencies and their contractors and agents, such as for example port inspectors, U.S. Coast Guard and the like. When deemed appropriate by the responsible authority the entire data or specific portions of the data may be made available to others such as shippers, importers and the like, for example, via secure login features. Depending upon the requirements the particular application, other communication devices may be used, such as for example, both active or passive, wireless devices, Wi-Fi certified devices, and wide band devices, as well as nano-barcode technology such as described for example at www.nanoplex.com that provides a covert and tamper resistant means of uniquely identifying tagged containers and/or tagged container contents capable of detecting if such a tagged article or container has been compromised to name but a few. The tracking of the containers and/or container contents is preferably assisted with GPS devices that are local to the container, to the container contents, and/or to the vessel carrying the containers.

According to one embodiment, the tagging device has certain information embedded in it. For example, this may include information such as the weight of the tagged container and/or tagged container contents, the time the tagged container and/or tagged container contents was loaded and sealed, the time it left the port of shipment or point of origin, the time of its arrival at the destination port, the temperature of the tagged container and/or tagged container contents, or some other similar information that is easily detected if altered. According to another embodiment, the tagging device has embedded in it and is capable of reading one or more micro-chips adapted to detect and report particular modalities such as ionizing radiation, temperature history, or the presence of selected molecules in the air. Based on the original information on the container, a profile of expected arrival and travel time can be generated. The container is tracked constantly or periodically by the communication device such as a satellite or other communications link and the transit information is compared to the generated profile. The satellite or other communications link transmits to all inspection points between the port of shipment or point of origin and the destination port of the container. It should be pointed out here that port of shipment, point of origin, destination port, and inspection points in between are construed to be locations where ships may dock or load/unload, where aircraft may operate, or where it might be possible to tamper with shipped goods (for example, the docking location of a warehouse).

If the transit of the container is substantially on profile, with no unexplained or unusual variations in time or location from the expected, and if the seal of the container shows no sign of tampering, then it can be assumed that the container is a trustable container and handled as such. As a result, the container spends little or no time being searched or identified at inspection points between the originating and destination ports including the destination port. This reduces the time the container has to spend in the ports which means that the container can reach the consumer quicker. Another advantage is that the containers reach their final destination without getting spoilt (for example, food items), and within the projected delivery schedule, thereby increasing the efficiency and value of imported goods. Yet another advantage is that it reduces the number of personnel and other equipment needed to inspect the container. Still another advantage for the embodiment where each content of a container is tagged, is that the system serves the dual function of inventory management and reporting as well as creating a trusted product import and supply chain. For example, if Wal-Mart® orders a shipment of movies on DVD from a manufacturer in China, then the system can report not only where and how many of these DVDs are en-route to a Wal-Mart® warehouse, but also if these DVDs contain illegal or pirated movies.

If the relevant information on the tagged device shows any change from the expected profile, then the container is assumed to have varied from its expected profile, indicating possible foul play or other effect producing occurrence that warrants inspection of the container. For example, a container containing chemical goods could sometimes erupt due to an unexpected change in temperature or pressure which would warrant a thorough inspection of the container even though no foul play resulted in the change. According to one embodiment, this container is no longer a trustable container and is treated perhaps like a container under the current system in which it may be held up and inspected. In other cases, an “untrustable” container my be automatically isolated and undergo a complete inspection.

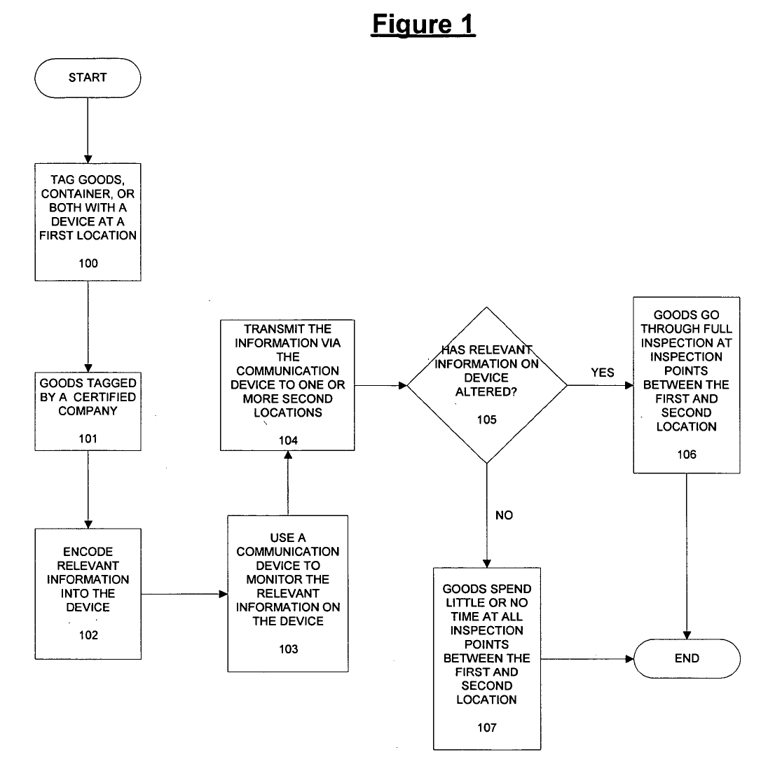

FIG. 1 illustrates an overall view of the present invention. At step 100, the container, its contents, or both are tagged with a device at a first location. This location is usually the point of origin and may in fact be the loading facility of a certified shipper. At step 101, this tagging is performed by either a certified company or the security personnel of the country of origin. At step 102, the device is embedded with certain relevant features of the container and/or its contents. At step 103, a communication device is used to monitor the relevant features of the container and/or its contents embedded in the device. At step 104, the information gathered by the communications device is transmitted to one or more locations different from the first location and along the route of the container. These locations are usually destination ports (if more than 1), or inspection locations between the port of shipment and final destination port. At step 105, a check is made at regular intervals to see if there has been any change to the relevant features of the container. At step 106, if the relevant features on the device have changed (the “yes” branch), then the container is isolated at the port of inspection or destination port and thoroughly inspected. If, on the other hand, the relevant features on the device have not changed (the “no” branch), then at step 107 the container is a trustable container and will spend little or no time at the port of inspection or destination port.

Module

According to one embodiment, the module collects the data, processes the data, and distributes the data received from the RFID tag. This module could be located at a centralized location or could be split up in several different locations. This module performs several tasks including embedding the tag with features, collecting and controlling the information received from the communication device, translating the information received from the tracking, and distributing this translated information to appropriate locations/governmental agencies. For example, IBM® designs the communication and computer systems that control the module. The task of embedding certain features of the container and/or its contents on the tag could be performed at the point of origin on instructions sent from the destination port. For example, Bayer® may want to tag its shipment of pharmaceuticals imported from Indonesia with information regarding the chemical content of the pharmaceuticals and the frequency at which the container should be monitored by the communication device. These tagging instructions are conveyed to the point of origin via the module (if the module is not present at the point of origin). The module then accesses the communication device to retrieve the tagging information received at the set frequency using data encryption technologies. The module then translates this information using data decryption and other communication security technologies and compares it with expected results. If the information received from the communication device matches the expected results, then the module informs the inspection ports or destination port that the container and/or its contents is trustable, else appropriate action is taken.

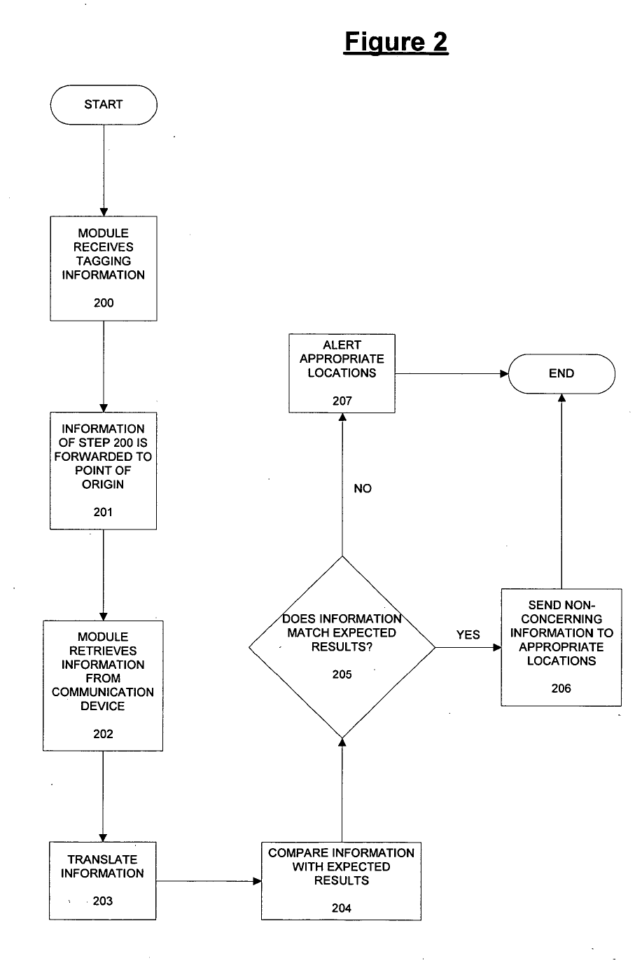

FIG. 2 illustrates the module and its functions. At step 200, a module receives tagging instructions from a purchaser of goods. At step 201, these instructions are forwarded to the point of origin where they are embedded into the tag. At step 202, the module retrieves from a communication device information received from tracking the tag. At step 203, this information is translated if needed. At step 204, this information is compared with known and expected results. At step 205, a check is made to see if the information received from the communication device matches the expected results. If it does (the “yes” branch), then at step 206 this non-concerning “trustable” information is forwarded to appropriate locations/government agencies/port authorities. If, on the other hand, the information received from the communications device does not match the expected results (the “no” branch), then at step 207 the module alerts the appropriate locations/government agencies/port authorities who would then take appropriate actions.

Thus, a system, a method, and an apparatus for decreasing the delay in inspection of container at a port are described in conjunction with one or more specific embodiments. The invention is defined by the following claims and their full scope and equivalents.

1. A tagging system, comprising:
a tag attached to a container containing one or more goods at a first location;
a means for embedding data to said tag;
a means for transmitting said data to a second location, wherein said first location is a different location from said second location;
a means for retransmitting data from said second location to a third location, wherein said second location is a different location from said third location, and said third location can be a same or different location from said first location;
a means for translating data at said third location; and
a means for distributing data from said third location to a fourth location, wherein said fourth location can be a same or different location from said third location.

2. The system of claim 1 wherein said tag is attached to each of said goods at said first location.

3. The system of claim 1 wherein said tag is an active RFID tag or a passive RFID tag.

4. The system of claim 1 wherein said first location, said third location, and said fourth location is a manufacturer, warehouse, seaport, airport, train terminal, or any other goods loading location.

5. The system of claim 4 wherein said fourth location is a government certified location.

6. The system of claim 1 wherein said means for embedding data to said tag is performed by a wireless device, a Wi-Fi certified device, or a wide band device.

7. The system of claim 1 wherein said means for transmitting, retransmitting, translating, and distributing data is performed wirelessly or wired.

8. The system of claim 1 wherein said second location is a satellite, or a GPS device.

9. A method to tag, comprising:
attaching said tag to a container containing one or more goods at a first location;
embedding data to said tag;
transmitting said data to a second location, wherein said first location is a different location from said second location;
retransmitting data from said second location to a third location, wherein said second location is a different location from said third location, and said third location can be a same or different location from said first location;
translating data at said third location; and
distributing data from said third location to a fourth location, wherein said fourth location can be a same or different location from said third location.

10. The method of claim 9 wherein said tag is attached to each of said goods at said first location.

11. The method of claim 9 wherein said tag is an active RFID tag or a passive RFID tag.

12. The method of claim 9 wherein said first location, said third location, and said fourth location is a warehouse, seaport, airport, train terminal, or any other goods loading location.

13. The method of claim 12 wherein said fourth location is a government certified location.

14. The method of claim 9 wherein embedding data to said tag is performed by a wireless device, a Wi-Fi certified device, or a wide band device.

15. The method of claim 9 wherein transmitting, retransmitting, translating, and distributing data is performed wirelessly or wired.

16. The method of claim 9 wherein said second location is a satellite, or a GPS device.

17. An apparatus, comprising:
a tag attached to a container containing one or more goods at a first location;
a means for embedding data to said tag;
a means for transmitting said data to a second location, wherein said first location is a different location from said second location;
a means for retransmitting data from said second location to a third location, wherein said second location is a different location from said third location, and said third location can be a same or different location from said first location;
a means for translating data at said third location; and
a means for distributing data from said third location to a fourth location, wherein said fourth location can be a same or different location from said third location.

18. The apparatus of claim 17 wherein said tag is attached to each of said goods at said first location.

19. The apparatus of claim 17 wherein said tag is an active RFID tag or a passive RFID tag.

20. The apparatus of claim 17 wherein said first location, said third location, and said fourth location is a warehouse, seaport, airport, train terminal, or any other goods loading location.

21. The apparatus of claim 20 wherein said fourth location is a government certified location.

22. The apparatus of claim 17 wherein said means for embedding data to said tag is performed by a wireless device, a Wi-Fi certified device, or a wide band device.

23. The apparatus of claim 17 wherein said means for transmitting, retransmitting, translating, and distributing data is performed wirelessly or wired.

24. The apparatus of claim 17 wherein said second location is a satellite, or a GPS device.
